(19) United States
(12) Patent Application Publication
(10) Pub. No.: US 2005/0041969 A1
(43) Pub. Date: Feb. 24, 2005

(54) Dynamic control of power loss in an optical fiber by contrapropagation of a supervisory channel

(75) Inventors: Arnaud Bisson, Orsay (FR); Emmanuel Rossi, Paris (FR); Guy Balland, Ste Genevieve Des Bois (FR)

Correspondence Address: SUGHRUE MION, PLLC;Suite 800, 2100 Pennsylvania Avenue, N.W., Washington, DC, 20037-3213, US

(73) Assignee: ALCATEL

(21) Appl. No.: 10/919,263

(22) Filed: Aug. 17, 2004

(30) Foreign Application Priority Data
Aug. 19, 2003 (FR) 03 09 998

(51) Int. Cl. H04B 10/08

(52) U.S. Cl. 398/30

(57) ABSTRACT

An optical system is dedicated to dynamically measuring power loss in an optical fiber (FO) having a first end (E1) and a second end (E2) respectively adapted to receive and to send primary optical signals. The system comprises injection means (3) adapted to inject supervisory signals into the second end (E2) of the optical fiber (FO) at a selected optical power and detection means (5) adapted to extract the supervisory signals at the first end (E1) of the optical fiber (FO) in order to determine their optical power and to deduce therefrom and from the selected optical power primary information representative of the optical power loss of the supervisory signals in the optical fiber (FO), and where applicable to compare the primary information to a value representative of a nominal power loss in the optical fiber (FO) in order to supply secondary information representative of a variation of the power loss in the optical fiber.

The invention relates to optical systems and more particularly to systems dedicated to measuring and/or controlling power loss in an optical signal transmission line.

Optical transmission lines induce optical power losses that degrade transmission performance and may lead to processing errors or even to loss of data. This is known in the art. The optical power losses are generally related to aging of the components that constitute the transmission lines (optical fibers, amplifiers, etc.) and/or to maintenance or repair work.

It has been proposed to monitor changing power loss in supervised transmission lines by using a supervisory channel that is dedicated to transporting binary network management information. To be more precise, it has been proposed to measure the power of “primary” optical signals representative of data to be transmitted (called “payload” data) reaching the output of the transmission optical fiber and then to integrate information representative of the output power into the supervisory signals and route the supervisory channel upstream of the optical fiber containing the primary signals using another optical fiber, in order to compare the output power to the previously determined input power.

That kind of solution is not satisfactory because integrating information representative of the output power into the supervisory signals necessitates analog-to-digital conversion. What is more, the time necessary for converting and routing the power information is not compatible with a procedure for dynamically adjusting the optical power.

Thus an object of the invention is to remedy the problems described above.

To this end the invention proposes a new optical system dedicated to dynamically measuring power loss in an optical transmission line comprising an optical fiber having a first end and a second end respectively adapted to receive primary optical signals from a send module, and to send the primary optical signals to a receive module.

The system is characterized in that it comprises injection means adapted to inject supervisory signals into said second end of said optical fiber at a selected optical power and detection means adapted to extract said supervisory signals at said first end of the optical fiber in order to determine their optical power and to deduce primary information therefrom and from said selected optical power, said primary information being representative of the optical power loss of the supervisory signals in the optical fiber.

According to another feature of the invention, the detection means are adapted to compare the primary information to a value representative of a nominal power loss in the optical fiber to supply secondary information representative of a variation of the power loss in the optical fiber. Thus the changing power loss induced by the optical fiber can be tracked dynamically.

Depending on requirements, the detection means may deliver secondary information that is either representative of the amplitude of the difference between the primary information and the chosen value or takes three states, namely a first state associated with a positive difference between the primary information and the selected value above a first threshold, a second state associated with a negative difference between the primary information and the selected value below a second threshold, and a third state associated with a difference between the first and second thresholds.

According to another feature of the invention, the system may comprise control means coupled to the detection means and to the first end of the fiber and adapted, when the detection means detect a variation in the power loss of the supervisory signals in the fiber, to modify the power of the primary signals injected into the fiber at its first end as a function of the detected power loss variation.

Accordingly, in the event of a variation (usually an increase) in the power loss of the supervisory signals in the fiber, the system may dynamically adjust the input power of the primary signals to maintain it substantially constant relative to a nominal output value.

To make this adjustment, the control means may comprise a variable optical attenuator (VOA) coupled to the first end of the fiber downstream of the detector means, for example. The VOA attenuates the power of the primary signals injected into the fiber and may be requested by the comparison means to reduce the attenuation if the secondary information is in its first state, to increase the attenuation if the secondary information is in its second state, or to leave the attenuation unchanged if the secondary information is in its third state.

Moreover, the detection means may comprise an optical filter adapted to extract the supervisory signals, an electronic circuit coupled to the filter and adapted to deliver the primary information, and, where applicable, comparison means adapted to compare the primary information to the value representative of the nominal power loss, in order to supply the secondary information.

The system may equally comprise power measuring means adapted to supply measurements representative of the power of the supervisory signals delivered by the supervisory means and auxiliary injection means adapted to apply auxiliary signals to the supervisory signals downstream of the second end (i.e. before injection) if the optical power of the primary signals at the second end is in a selected range. In this case, the detection means advantageously comprise means for detecting auxiliary signals which, when they detect auxiliary signals, enable the control means to take account of the secondary information.

Alternatively, the system may comprise auxiliary injection means adapted to apply auxiliary signals to the supervisory signals downstream of the second end and control means adapted to control the relative amplitude of the auxiliary signals delivered by the auxiliary injection means, so that this relative amplitude is inversely proportional to the power of the supervisory signals delivered by the supervisory means and the auxiliary signals have an absolute amplitude that is substantially constant and independent of the power of the supervisory signals. In this case, the detection means advantageously comprise measuring means adapted to deliver measurements representative of the amplitude of the auxiliary signals applied to the supervisory signals (and constituting the primary information).

For example, the auxiliary injection means are adapted to deliver auxiliary signals for amplitude modulating the supervisory signals.

The supervisory means may equally comprise feedback means adapted to set the power of the supervisory signals before they are injected into the second end of the optical fiber.

The invention also proposes a method dedicated to dynamically measuring power loss in an optical transmission line comprising an optical fiber having a first end and a second end respectively adapted to receive primary optical signals from a send module and to send the primary optical signals to a receive module.

The method is characterized in that it consists in injecting supervisory signals into the second end of the optical fiber at a selected optical power and then extracting the supervisory signals at the first end of the optical fiber to determine their optical power and to deduce therefrom and from the selected optical power primary information representative of the optical power loss of the supervisory signals in the optical fiber.

According to another feature of the method, the primary information is compared to a value representative of a nominal power loss in the fiber in order to provide secondary information representative of a variation in the power loss in the optical fiber.

In this case, the secondary information delivered is preferably representative of the difference between the primary information and the selected (nominal) value. For example, the secondary information is either representative of the amplitude of the difference or takes three states, as indicated above.

According to a further feature of the method, in the event of detection of a variation in the power loss of the supervisory signals, the power of the primary signals injected into the first end of the fiber may be modified as a function of the detected variation.

Moreover, when the secondary information is in its first state the attenuation of the primary signals may be reduced, when the secondary information is in its second state the attenuation of the primary signals may be increased, and when the secondary information is in its third state the attenuation of the primary signals may be left unchanged.

The power of the supervisory signals may also be measured downstream of the second end and auxiliary signals applied to the supervisory signals downstream of the second end if the optical power of the primary signals at the second end is in a selected range. In this case, if auxiliary signals are detected upstream of the first end, modification of the power of the primary signals injected into the first end of the optical fiber as a function of the secondary information may be authorized.

Alternatively, auxiliary signals may be applied to the supervisory signals downstream of the second end and their relative amplitude controlled so that their value is inversely proportional to the power of the supervisory signals injected at the second end and the absolute amplitude of the auxiliary signals is substantially constant and independent of the power of the supervisory signals. In this case, the amplitude of the auxiliary signals applied to the supervisory signals may be measured upstream of the first end of the optical fiber (these measurements constitute the primary information).

The power of the supervisory signals may also be set before injecting them into the second end of the optical fiber.

The system and the method of the invention are particularly, although not exclusively, suitable for measuring and/or controlling dynamically power loss on optical transmission lines used in the field of telecommunications, in particular when said lines transport (Dense) Wavelength-Division Multiplex ((D)WDM) data channels.

Other features and advantages of the invention will become apparent on examining the following detailed description and the appended drawings, in which:

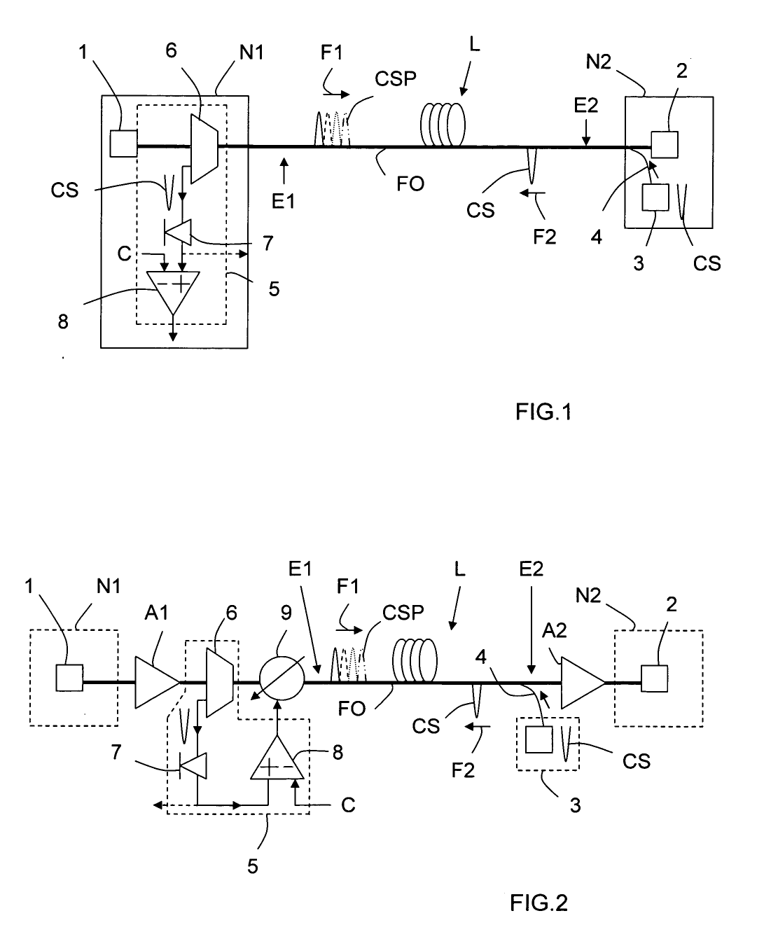

FIG. 1 shows diagrammatically a first embodiment of an optical system of the invention,

FIG. 2 shows diagrammatically a second embodiment of an optical system of the invention,

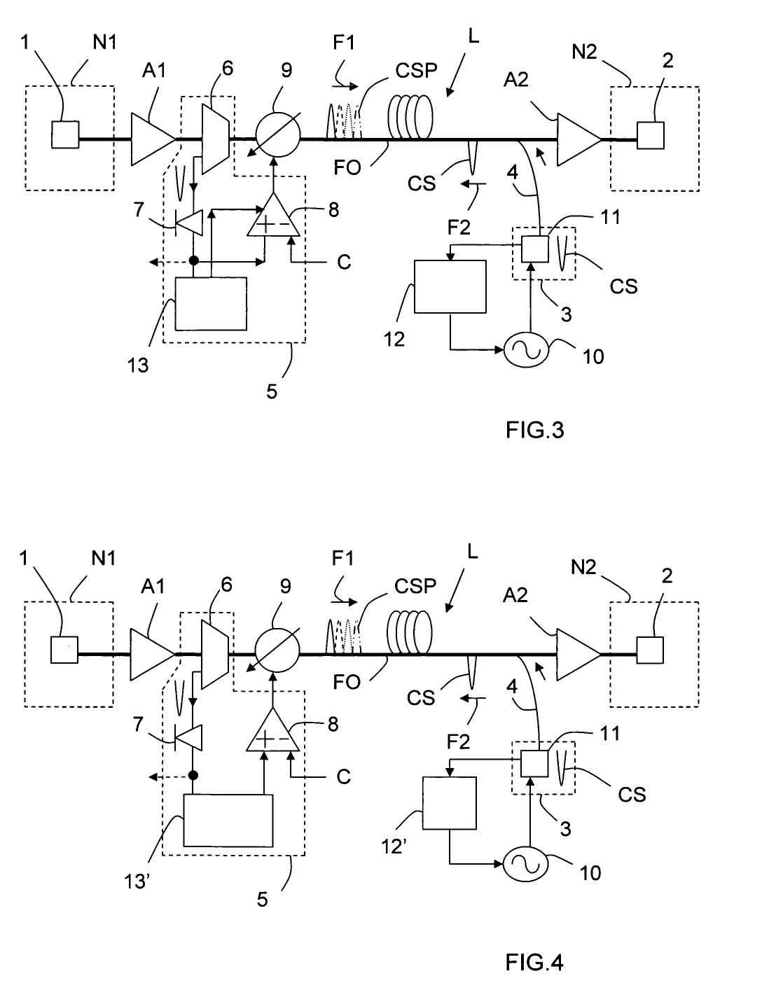

FIG. 3 shows diagrammatically a third embodiment of an optical system of the invention, and

FIG. 4 shows diagrammatically a fourth embodiment of an optical system of the invention.

The appended drawings constitute part of the description of the invention and may, if necessary, also contribute to the definition of the invention.

The invention is intended for measuring and/or controlling power loss in an optical signal transmission line.

The transmission line is considered below as being dedicated to transporting wavelength-division multiplexed channels.

A first embodiment of an optical system of the invention that is installed on an optical transmission line L between two nodes N1 and N2 of a WDM or DWDM telecommunication network is described first with reference to FIG. 1. The nodes are network equipment units such as routers, switches, amplifiers or regenerators, for example.

Here the line L consists of a bidirectional optical fiber FO that has a first end E1 connected to the first node N1 and an opposite second end E2 connected to the second node N2. Although it is bidirectional, the optical fiber FO is dedicated to transmitting primary optical signals representative of data to be transmitted, for example in the form of wavelength-division multiplexed (WDM) CSP channels (or aggregates), from the first node N1, or to be more precise its sending module 1, to the second node N2, or to be more precise its receive module 2 (arrow F1).

Of course, the transmission line may comprise a plurality of optical fibers, in particular for transmitting primary signals from the second node N2 to the first node N1.

The optical fiber FO has a known nominal power loss.

The system of the invention includes a supervisory module 3 connected to the second end E2 of the fiber FO via an insertion device 4, for example a 2×1 optical coupler or an optical filter. Here the supervisory module 3 is installed in the second node N2 but it could instead be external to the node. The supervisory module 3 is adapted to inject into the second end E2 of the fiber FO a supervisory channel CS having a specific wavelength and containing supervisory signals representative of binary network management information. The (selected) optical power of the channel CS must be as constant as possible because any variations in the power of the supervisory channel CS reduce the reliability of the system. It is possible to set the power of the supervisory channel to measure losses in the transmission line L more accurately. For example, a control module coupled to a module 11 of the supervisory module 3 for sending supervisory signals may be used for this purpose.

According to the invention, the supervisory channel CS contrapropagates in the fiber FO (arrow F2) with respect to the multiplexed CSP channels containing the primary signals (arrow F1). The supervisory channel CS is received at the first end E1 of the fiber FO by a detection module 5 of the optical system of the invention.

Here, the detection module 5 is installed in the first node N1 but it could instead be external to the node. The detection module 5 is adapted to extract the supervisory signals from the fiber FO to deduce therefrom, in particular, primary information representative of their optical output power.

To this end, the detection module 5 includes, for example, a demultiplexer 6 adapted to extract from the fiber FO only the supervisory channel CS, in order to deliver the supervisory signals that it contains to an electronic circuit 7, preferably a photodiode circuit, that is used not only to detect the binary supervisory information but also to measure its average output power. Knowing the nominal power of the supervisory signals generated by the supervisory module 3 and the insertion and extraction losses of the supervisory channel CS (as determined by calibration), the electronic circuit 7 may deduce the real power loss induced by the fiber FO. It therefore delivers primary information that is representative not only of the average power of the supervisory signals but also of the real power loss induced by the fiber FO.

The detection module 5 may also be adapted, as shown here, to compare the primary information delivered by the electronic circuit 7 to a value C representative of the nominal optical power loss in the fiber FO, in order to deliver secondary information representative of a variation in the power loss of the supervisory signals in said fiber FO. Thus the changing power loss can be tracked dynamically.

To this end, the detection module 5 may comprise a comparator 8 coupled to the output of the electronic circuit 7 and adapted to compare the primary information that it delivers to a set point C representative of the nominal optical power loss of the supervisory signals in the fiber FO, for example.

The primary information and the set point C are preferably fed to a non-inverting (+) input and an inverting (−) input, respectively, of the comparator 8. The set point C therefore enables the comparator 8 to estimate the difference between the nominal loss of the fiber FO and the real loss induced by the fiber.

The comparator 8 therefore receives the primary information, compares it to the set point C, and supplies secondary information representative of the difference between the primary information and the set point C, in other words representative of a variation of the power loss in the fiber FO relative to a selected nominal value. The secondary information may be either directly representative of the amplitude of the measured difference or take three states, namely a first state associated with a positive difference between the primary information and the selected nominal value above a first threshold S1, a second state associated with a negative difference between the primary information and the selected nominal value below a second threshold S2, and a third state associated with a difference between the first threshold S1 and the second threshold S2.

In this first embodiment, the system of the invention therefore comprises a supervisory module 3 associated with an insertion device 4 and a detection module 5 at both ends E1 and E2 of the optical fiber FO.

In a second embodiment, shown in FIG. 2, the system of the invention also adjusts the power of the primary signals at the first end E1 of the fiber FO.

To this end it comprises a control module 9 adapted to modify the power of the primary signals before they are injected into the first end E1 of the fiber FO. The control module 9 comprises a variable optical attenuator (VOA), for example.

In this embodiment, the detection device 5 is no longer internal to the first node N1. It is now external to the first node N1 and between a first amplifier A1 and the control module 9. What is more, the supervisory module 3 is no longer internal to the second module M2. It is now at the second end E2 of the fiber FO, just ahead of a second amplifier A2 installed at the input of the second node N2.

Because of this arrangement, the supervisory signals that are sampled by the demultiplexer 6 of the detection module 5 are attenuated beforehand by the VOA (control module) 9. Consequently, in the event of detection of a variation (generally an increase) in the power loss in the fiber FO, the VOA 9 reduces the attenuation (i.e. compensates the increase in the power loss in the fiber), which is equivalent to amplifying (modulated) primary signals at the first end E1 so that they have a nominal output power at the second end E2 after travelling through the optical fiber FO.

Accordingly, when the comparator 8 delivers to the control module (VOA) 9 secondary information in the first state, for example, the control module reduces the attenuation by a selected amount, for example approximately 1 dB. Conversely, when the comparator 8 delivers to the control module (VOA) 9 secondary information in the second state, the control module increases the attenuation by a selected amount, for example approximately 1 dB. If the comparator 8 delivers to the control module (VOA) 9 secondary information in the third state, the control module leaves the attenuation unchanged.

Alternatively, if the secondary information represents the amplitude of the difference between the nominal loss of the fiber (C) and the real loss, the control module (VOA) 9 reduces the attenuation by an amount substantially equal to the difference. Thus only a variation in the power loss induced by the fiber FO leads to automatic adjustment of the attenuation.

The system of the invention here comprises a supervisory module 3 at the second end E2 of the optical fiber FO and a detection module 5 and a control module 9 at the first end E1 of the optical fiber FO.

A third embodiment of a system of the invention is described next with reference to FIG. 3. This embodiment is in fact a variant of the second embodiment described above with reference to FIG. 2.

This third embodiment takes the whole of the system from the second embodiment and adds to it an auxiliary injection module 10 and an auxiliary detection module 13.

To be more precise, the auxiliary injection module 10 is adapted to apply amplitude modulation (Tone) to the supervisory channel CS sent by the sending module 11 of the supervisory module 3 when the power of the supervisory channel is deemed sufficiently close to the nominal value. This Tone, which constitutes the auxiliary signals, may be a sinusoid having a low amplitude (typically 5% of the power of the supervisory channel CS) and applied directly to the sending module 11 of the supervisory module 3, as shown here.

To determine if the power of the supervisory channel CS is acceptable, it is measured by a power measuring module 12 (either internally in the supervisory module 3, as shown here, or via a coupler between the sending module 11 of the supervisory module 3 and the insertion device 4) and compared to a power range centered on a nominal value. The Tone is applied by the auxiliary injection module 10 when the measured power of the supervisory channel CS is in the nominal range. If the power of the supervisory channel CS is outside that range (i.e. too high or too low), the Tone is not applied because the measured losses of the fiber FO deduced from the power of the supervisory channel CS detected by the detection module 5 would otherwise be incorrect.

The detection module 5 comprises a Tone detector circuit 13 coupled to the output of the electronic circuit 7 and to the comparator 8 and adapted to determine if the measurements of the losses in the fiber FO may be declared reliable or not. Thus when the Tone is detected, the Tone detector circuit 13 activates the control module 9 to compensate the detected power variations. If, however, the Tone is not detected, the Tone detector circuit 13 deactivates (or locks) the control module 9 because the measurements of the losses in the fiber FO have been declared unreliable.

Thus in this configuration the Tone has two states, active and inactive. In the active state, the power of the supervisory channel CS is in the nominal range. The measurements of the losses in the fiber FO are therefore reliable and the auxiliary injection module 10 modulates the supervisory channel CS (typically using a sinusoid with an amplitude close to 5%). In the inactive state, the power of the supervisory channel CS is outside the nominal range. Measurements of the losses of the fiber FO being unreliable in this situation, no modulation is added to the supervisory channel CS by the auxiliary injection module 10.

Here the system of the invention comprises a supervisory module 3, a power measuring module 12, and an auxiliary injection module 10 at the second end E2 of the optical fiber FO and a detection module 5 comprising a Tone detector module 13 and a control module 9 at the first end E1 of the optical fiber FO.

A fourth embodiment of a system of the invention is described next with reference to FIG. 4. This embodiment is in fact a variant of the third embodiment described above with reference to FIG. 3. This variant is more reliable.

In this variant, the Tone that again constitutes the auxiliary signals no longer has two states (active/inactive). The relative amplitude of its modulation (typically from 1 to 10%) is now inversely proportional to the power of the supervisory channel CS delivered by the send module 11 of the supervisory module 3, so that at the input end E2 of the fiber FO the absolute amplitude of the Tone is constant and independent of the power of the supervisory channel CS. The power measurement module 12 is therefore replaced here by a Tone control module 12′ that drives the auxiliary injection module 10.

Consequently, in this variant, for evaluating the losses in the fiber FO and driving the control module 9 accordingly, the detection module 5 is based on the (modulation) amplitude of the Tone applied to the supervisory channel CS, rather than its power.

To this end, the detection module 5 comprises a circuit 13′ delivering measurements representative of the amplitude of the Tone constituting the primary information. The output of the electronic circuit 7 therefore feeds the Tone measuring circuit 13 which in turn supplies the comparator 8 with primary information representative of the amplitude of the Tone, which it may then compare to the set point C to generate secondary information for driving the control module (VOA) 9.

The system of the invention here comprises a supervisory module 3, a Tone control module 12′, and an auxiliary injection module 10 at the second end E2 of the optical fiber FO and a detection module 5 comprising a Tone measuring circuit 13′ and a control module 9 at the first end E1 of said optical fiber FO.

It is important to note that in the embodiments shown in FIGS. 2 to 4 the detection module 5 and/or the amplifier A1 and/or the control module (VOA) 9 may be integrated into the first node N1. Similarly, in the embodiments shown in FIGS. 3 and 4, the supervisory module 3 and its insertion device 4 and/or the auxiliary injection module 10 and/or the power measurement module 12 (or the Tone control module 12′) and/or the amplifier A2 may be integrated into the second node N2.

The invention also proposes a method dedicated to dynamically measuring power loss in an optical transmission line L comprising an optical fiber FO.

This method may be implemented using the system, the transmission line L and the nodes N1 and N2 described hereinabove. The main and optional functions and sub-functions of the steps of this method being substantially identical to those of the means constituting the system and/or the nodes N1 and N2, only the steps implementing the main functions of the method of the invention are summarized below.

The method consists in injecting supervisory signals into the second end E2 of the fiber FO at a selected optical power and then extracting the supervisory signals at the first end E1 of the fiber FO to determine their optical power and to deduce therefrom and from the selected optical power primary information representative of the optical power loss of the supervisory signals in the fiber, and where applicable to compare the primary information to a value representative of a nominal power loss in the fiber FO, in order to supply secondary information representative of a variation in the power loss in the optical fiber FO.

The method may equally comprise a complementary adjustment (or regulation) step in which, in the event of detection of an (unauthorized) variation of the power loss induced by the fiber FO, the power of the signals injected into the first end E1 of the fiber FO is modified as a function of the detected variation.

The invention is not limited to the embodiments of the system and the method described hereinabove by way of example only, but encompasses all variants that the person skilled in the art might envisage that fall within the scope of the following claims.

1. An optical system for dynamically measuring power loss in an optical transmission line (L) comprising an optical fiber (FO) having a first end (E1) and a second end (E2) respectively adapted to receive primary optical signals from a send module (1), and to send the primary optical signals to a receive module (2), which system is characterized in that it comprises injection means (3) adapted to inject supervisory signals into said second end (E2) of said optical fiber (FO) at a selected optical power and detection means (5) adapted to extract said supervisory signals at said first end (E1) of the optical fiber (FO) in order to determine their optical power and to deduce primary information therefrom and from said selected optical power, said primary information being representative of the optical power loss of the supervisory signals in the optical fiber (FO).

2. A system according to claim 1, characterized in that said detection means (5) are adapted to compare said primary information to a value representative of a nominal power loss in the optical fiber (FO) in order to supply secondary information representative of a variation of the power loss in said optical fiber (FO).

3. A system according to claim 2, characterized in that said detection means (5) are adapted to deliver secondary information representative of the difference between said primary information and said representative value.

4. A system according to claim 3, characterized in that said detection means (5) are adapted to deliver secondary information representative of the amplitude of said difference.

5. A system according to claim 3, characterized in that said detection means (5) are adapted to deliver secondary information with three states, namely a first state associated with a positive difference between said primary information and said representative value above a first threshold, a second state associated with a negative difference between said primary information and said representative value below a second threshold, and a third state associated with a difference that lies between said first and second thresholds.

6. A system according to claim 1, characterized in that it comprises control means (9) coupled to said detection means (5) and to said first end (E1) of the optical fiber (FO) and adapted, in the event of detection by said detection means (5) of a variation in the power loss of the supervisory signals in the fiber (FO), to modify the power of the primary signals injected into the first end (E1) of the optical fiber (FO) as a function of said detected power loss variation.

7. A system according to claim 6, characterized in that said control means (9) comprise a variable optical attenuator coupled to said first end (E1) of the optical fiber (FO).

8. A system according to claim 5, characterized in that it comprises control means (9) in the form of a variable optical attenuator coupled to said first end (E1) of the optical fiber (FO) and adapted, in the event of detection by said detection means (5) of a variation in the power loss of the supervisory signals in the fiber (FO), to modify the power of the primary signals injected into the first end (E1) of the optical fiber (FO) as a function of said detected power loss variation, said system being further characterized in that said control means (9) are adapted to reduce the attenuation if said secondary information is in its first state, to increase the attenuation if said secondary information is in its second state, and to leave the attenuation unchanged if said secondary information is in said third state.

9. A system according to claim 1, characterized in that said detection means (5) comprise an optical filter (6) for extracting said supervisory signals and an electronic circuit (7) coupled to said optical filter (6) and adapted to supply said primary information.

10. A system according to claim 2, characterized in that said detection means (5) comprise an optical filter (6) for extracting said supervisory signals and an electronic circuit (7) coupled to said optical filter (6) and adapted to supply said primary information, and further characterized in that said detection means (5) comprise comparison means (8) coupled to said electronic circuit (7) and adapted to compare said primary information to the value representative of the nominal power loss in order to supply said secondary information.

11. A system according to claim 1, characterized in that it comprises power measuring means (12) adapted to supply measurements representative of the power of said supervisory signals delivered by said supervisory means (3) and auxiliary injection means (10) adapted to apply auxiliary signals to said supervisory signals downstream of said second end (E2) of the optical fiber (FO) if the primary signals at said second end (E2) have an optical power whose value is in a selected range.

12. A system according to claim 11, characterized in that said detection means (5) comprise means for detecting said auxiliary signals (13) adapted if they detect said auxiliary signals to enable said control means (9) to take account of said secondary information.

13. A system according to claim 1, characterized in that it comprises auxiliary injection means (10) adapted to apply auxiliary signals to said supervisory signals downstream of said second end (E2) and control means (12′) adapted to control the relative amplitude of said auxiliary signals delivered by said auxiliary injection means (10) so that said relative amplitude is inversely proportional to the power of the supervisory signals delivered by said supervisory means (3) and said auxiliary signals have a substantially constant absolute amplitude independent of the power of said supervisory signals.

14. A system according to claim 13, characterized in that said detection means (5) comprise measuring means (13′) adapted to supply measurements representative of the amplitude of said auxiliary signals applied to said supervisory signals and constituting said primary information.

15. A system according to claim 10, characterized in that said auxiliary injection means (10) are adapted to supply auxiliary signals for modulating the amplitude of said supervisory signals.

16. A system according to claim 1, characterized in that said supervisory means (3) comprise feedback means adapted to set the power of said supervisory signals before they are injected into said optical fiber (FO).

17. A method of dynamically measuring power loss in an optical transmission line (L) comprising an optical fiber (FO) having a first end (E1) and a second end (E2) respectively adapted to receive primary optical signals from a send module (1) and to send the primary optical signals to a receive module (2), which method is characterized in that it consists in injecting supervisory signals into said second end (E2) of said optical fiber (FO) at a selected optical power and then extracting said supervisory signals at said first end (E1) of the optical fiber (FO) in order to determine their optical power and to deduce therefrom and from said selected optical power primary information representative of the optical power loss of the supervisory signals in the optical fiber (FO).

18. A method according to claim 17, characterized in that said primary information is compared to a value representative of a nominal power loss in the optical fiber (FO) in order to supply secondary information representative of a variation in the power loss in said optical fiber (FO).

19. A method according to claim 18, characterized in that said secondary information is representative of the difference between said primary information and said representative value.

20. A method according to claim 19, characterized in that the secondary information is representative of the amplitude of said difference.

21. A method according to claim 19, characterized in that the secondary information has three states, namely a first state associated with a positive difference between said primary information and said representative value above a first threshold, a second state associated with a negative difference between said primary information and said representative value below a second threshold, and a third state associated with a difference that lies between said first and second thresholds.

22. A method according to claim 17, characterized in that, in the event of detection of a variation in the power loss of the supervisory signals in the optical fiber (FO), the power of the primary signals injected into the first end (E1) of the optical fiber (FO) is modified as a function of said detected power loss variation.

23. A method according to claim 21, characterized in that, in the event of detection of a variation in the power loss of the supervisory signals in the optical fiber (FO), the power of the primary signals infected into the first end (E1) of the optical fiber (FO) is modified as a function of said detected power loss variation, and further characterized in that if said secondary information is in its first state the attenuation of the primary signals is reduced, if said secondary information is in its second state the attenuation of the primary signals is increased, and if said secondary information is in its third state the attenuation of the primary signals is left unchanged.

24. A method according to claim 17, characterized in that the power of said supervisory signals is measured downstream of said second end (E2) of the optical fiber (FO) and auxiliary signals are applied to said supervisory signals downstream of said second end (E2) if the primary signals at said second end (E2) have an optical power whose value is in a selected range.

25. A method according to claim 24, characterized in that, in the event of detection of said auxiliary signals upstream of said first end (E1) of the optical fiber (FO), modification of the power of the primary signals injected into the first end of the optical fiber (FO) as a function of said secondary information is authorized.

26. A method according to claim 17, characterized in that auxiliary signals are applied to said supervisory signals downstream of said second end (E2), their relative amplitude being inversely proportional to the power of the supervisory signals injected at the second end (E2), and said auxiliary signals have a substantially constant absolute amplitude that is independent of the power of said supervisory signals.

27. A method according to claim 26, characterized in that the amplitude of said auxiliary signals applied to said supervisory signals is measured upstream of said first end (E1) of the optical fiber (FO), said measurements constituting said primary information.

28. A method according to claim 24, characterized in that said auxiliary signals modulate the amplitude of said supervisory signals.

29. A method according to claim 17, characterized in that the power of said auxiliary signals is set before they are injected into said optical fiber (FO).

30. The use of a system and a method according to claim 17 in the field of telecommunications.
